(19) United States
(12) Patent Application Publication
(10) Pub. No.: US 2014/0346928 A1
(43) Pub. Date: Nov. 27, 2014

(54) VIBRATION GENERATING APPARATUS

(71) Applicant: Samsung Electro-Mechanics Co. Ltd., Suwon (KR)

(72) Inventor: Jae Woo Jun, Suwon (KR)

(73) Assignee: Samsung Electro-Mechanics Co., Ltd., Suwon (KR)

(21) Appl. No.: 13/959,674

(22) Filed: Aug. 5, 2013

(30) Foreign Application Priority Data
May 23, 2013 (KR) 10-2013-0058567

(51) Int. Cl. H02N 2/00

(52) U.S. Cl. CPC H02N 2/006
USPC 310/329

(57) ABSTRACT

There is provided a vibration generating apparatus including: a housing having an internal space; an elastic member having an edge part fixedly attached to the housing; a piezoelectric element fixedly attached to a lower surface of a central portion of the elastic member; and a mass body fixedly attached to an upper surface of the central portion of the elastic member.

### CROSS-REFERENCE TO RELATED APPLICATIONS

This application claims the priority of Korean Patent Application No. 10-2013-0058567 filed on May 23, 2013, in the Korean Intellectual Property Office, the disclosure of which is incorporated herein by reference.

### BACKGROUND OF THE INVENTION

1. Field of the Invention

The present invention relates to a vibration generating apparatus.

2. Description of the Related Art

A vibration generating apparatus, a component converting electrical energy into mechanical vibrations through the generation of electromagnetic force, is commonly mounted in a mobile phone to be used to silently notify a user of call reception by transferring vibrations thereto.

Meanwhile, in accordance with rapid growth in the mobile phone market and the trend for adding functionality to mobile phones, mobile phone components having a compact size and a high degree of quality have been required. In this situation, the demand for the development of a vibration generating apparatus having a novel structure capable of overcoming the disadvantages of existing vibration generating apparatuses, and having significantly improved quality with respect thereto, has increased.

In addition, as the release of smartphones has rapidly increased, a touchscreen scheme has been adopted therein, such that in addition to silently notifying a user of call reception, vibration generating apparatuses have been used in order to generate vibrations when the touchscreen is touched.

Degrees of performance required of the vibrations generated when the touchscreen is touched in particular, are as follows. First, since vibrations are generated more frequently in devices having touchscreens than in phones merely vibrating at the time of call reception, an operational lifespan of a vibration generating apparatus should be increased. Second, in order to improve user satisfaction when a user is provided with vibrations when the touchscreen is touched, a vibration response speed should be increased, in accordance with a speed at which the screen is touched.

In this regard, a piezo haptic actuator has been used as a product able to provide such levels of performance. The piezo haptic actuator uses an inverse piezoelectric effect in which displacement is generated when a voltage is applied to a piezo-element, that is, a principle of allowing a mass body provided on a movable element to be moved by the generated displacement to generate vibration force.

A vibrator having the above-mentioned structure has the following features. A bandwidth of a frequency able to provide a predetermined level of vibration force or greater is wide, such that stable vibration characteristics may be implemented with the use thereof, and vibrations having low and high frequencies within a predetermined frequency range, rather than a single frequency, may be variously used. In addition, since the vibrator may implement rapid operational response characteristics, it may be appropriate for implementing haptic feedback vibrations in a mobile device such as a mobile phone, or the like.

Meanwhile, the piezo-element generally is formed to have a rectangular parallelepiped shape. In this case, since the length of the piezo-element should be relatively long, in order to secure displacement and vibrations, the entire length of the vibration generating apparatus may be increased, and the piezo-element is vulnerable to external impacts, such as those caused by a product being dropped.

Further, since the overall shape of the vibration generating apparatus is a rectangular parallelepiped, the overall volume thereof may be increased, such that miniaturization of components may not be feasible.

### RELATED ART DOCUMENT

(Patent Document 1) Korean Patent Laid-Open Publication No. 2006-0000894

### SUMMARY OF THE INVENTION

An aspect of the present invention provides a vibration generating apparatus having a coin-like shape, that is, a circular shape when viewed from above.

According to an aspect of the present invention, there is provided a vibration generating apparatus including: a housing having an internal space; an elastic member having an edge part fixedly attached to the housing; a piezoelectric element fixedly attached to a lower surface of a central portion of the elastic member; and a mass body fixedly attached to an upper surface of the central portion of the elastic member.

The piezoelectric element may have a coin-like shape.

The elastic member may include a housing bonding part fixedly attached to the housing and having a ring shape, an installation plate having the piezoelectric element and the mass body fixedly attached thereto, and an elastic deformation part connecting the housing bonding part and the installation plate to each other and providing elastic force.

The housing bonding part and the installation plate may be disposed to be spaced apart from each other by a predetermined interval in a thickness direction of the housing, and the elastic deformation part may be disposed to be inclined.

The mass body may include a mass body case fixedly attached to the upper surface of the central portion of the elastic member and a mass body inserted into the mass body case.

The housing may include an upper case having a cylindrical shape in which an upper end portion thereof is closed and a bracket attached to a lower end portion of the upper case, and the upper case and the bracket may have a circular shape when viewed from above.

The bracket may be provided with support jaws for supporting an edge of the elastic member.

A plurality of support jaws may be disposed in a circumferential direction so as to be spaced apart from each other and be formed in a ring.

The vibration generating apparatus may further include a circuit board having one end connected to the piezoelectric element and the other end drawn out to the outside of the housing.

The housing may include an upper case having a cylindrical shape in which an upper end portion thereof is closed and a bracket attached to a lower end portion of the upper case, and the bracket may be provided with a withdrawal hole through which the other end of the circuit board is drawn out.

According to another aspect of the present invention, there is provided a vibration generating apparatus including: a housing including an upper case having a cylindrical shape in which an upper end portion thereof is closed and a bracket attached to a lower end portion of the upper case and having a plate shape; an elastic member including a housing bonding part fixedly attached to the bracket, a plurality of elastic deformation parts extended from the housing bonding part, and an installation plate having the plurality of elastic deformation parts connected thereto; a piezoelectric element fixedly attached to a lower surface of the installation plate of the elastic member; a mass body case fixedly attached to an upper surface of the installation plate; a mass body inserted into the mass body case; and a circuit board having one end connected to the piezoelectric element and the other end drawn out to the outside of the housing.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a vibration generating apparatus according to an embodiment of the present invention;

FIG. 2 is an exploded perspective view showing the vibration generating apparatus according to the embodiment of the present invention;

FIG. 3 is a cross-sectional view showing the vibration generating apparatus according to the embodiment of the present invention;

FIG. 4 is a perspective view showing an elastic member included in the vibration generating apparatus according to the embodiment of the present invention;

FIG. 5 is an exploded perspective view showing a vibration generating apparatus according to another embodiment of the present invention;

FIG. 6 is a cross-sectional view showing the vibration generating apparatus according to another embodiment of the present invention; and

FIG. 7 is a perspective view showing an elastic member included in the vibration generating apparatus according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

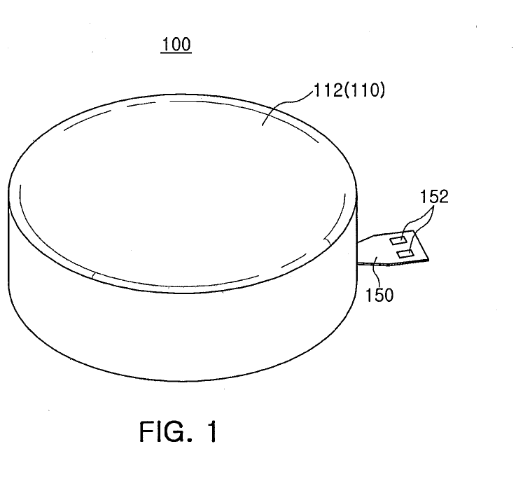

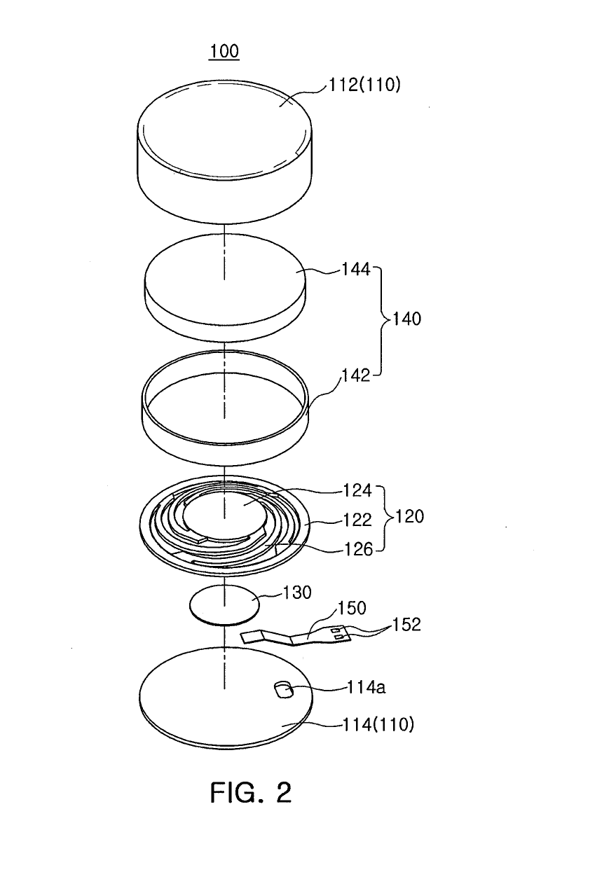

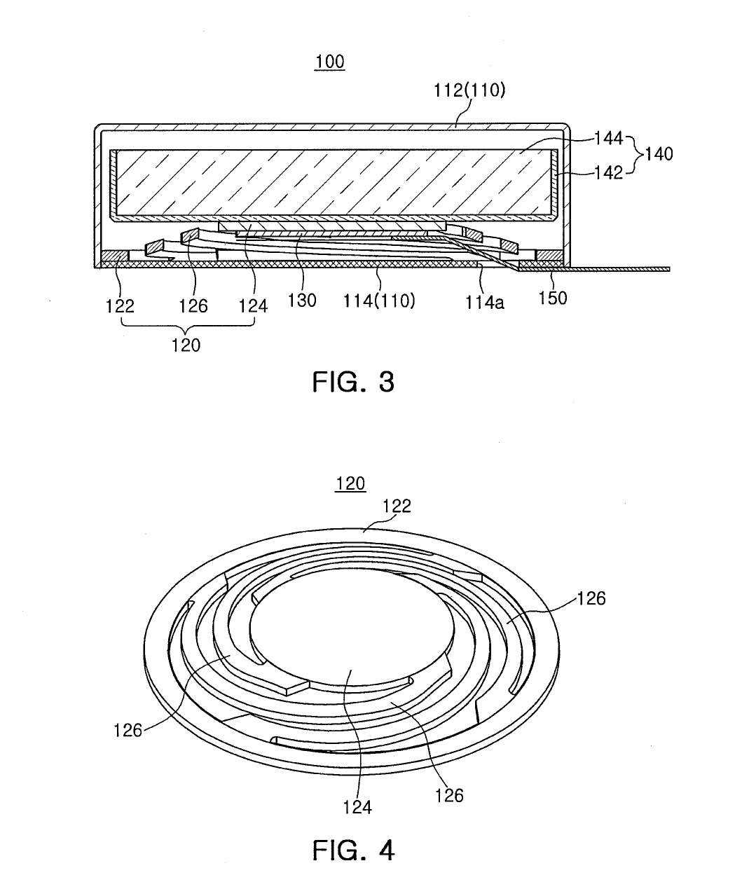

FIG. 1 is a perspective view showing a vibration generating apparatus according to an embodiment of the present invention; FIG. 2 is an exploded perspective view showing the vibration generating apparatus according to the embodiment of the present invention; FIG. 3 is a cross-sectional view showing the vibration generating apparatus according to the embodiment of the present invention; and FIG. 4 is a perspective view showing an elastic member included in the vibration generating apparatus according to the embodiment of the present invention.

Referring to FIGS. 1 through 4, the vibration generating apparatus 100 according to the embodiment of the present invention may include a housing 110, an elastic member 120, a piezoelectric element 130, a mass body 140, and a circuit board 150 by way of example.

The housing 110 may have an internal space. To this end, the housing 110 may include an upper case 112 and a bracket 114.

The upper case 112 may have a cylindrical shape in which an upper end portion thereof is closed. That is, the upper case 112 may have the internal space and an opened lower end portion and have a circular shape when viewed from above.

However, the upper case 112 is not limited to having the cylindrical shape, but may also have a box shape, for example, a cube shape in which a lower end portion thereof is open.

The bracket 114 may be attached to the lower end portion of the upper case 112 and have a plate shape. That is, the bracket 114 may have a shape corresponding to that of the upper case 112, for example, a circular shape when viewed from above.

In addition, the shape of the bracket 114 may be changed according to a deformation of the shape of the upper case 112.

Further, the bracket 114 may have a withdrawal hole 114a formed therein so that a circuit board 150 may be drawn out to the outside.

The elastic member 120 may have an edge part fixedly attached to the housing 110. Meanwhile, the elastic member 120 may include a housing bonding part 122 fixedly attached to the housing 110 and having a ring shape, an installation plate 124 having the piezoelectric element 130 and the mass body 140 fixedly attached thereto, and an elastic deformation part 126 connecting the housing bonding part 122 and the installation plate 124 to each other and providing elastic force.

The housing bonding part 122 may be fixedly attached to the bracket 114 of the housing 110 and have a circular ring shape so as to correspond to the shape of the bracket 114. However, the shape of the housing bonding part 122 may also be variously changed so as to correspond to that of the bracket 114.

The installation plate 124 may have a circular plate shape and be connected to the elastic deformation part 126.

In addition, the installation plate 124 may be disposed to be spaced apart from the housing bonding part 122 by a predetermined interval in a thickness direction of the housing 120. In other words, the installation plate 124 may be disposed to protrude upwardly from the housing bonding part 122.

In addition, the installation plate 124 may be connected to a plurality of elastic deformation parts 126 to thereby move upwardly and downwardly at the time of movement of the elastic deformation parts 126.

Meanwhile, the elastic deformation parts 126 may be extended from an inner peripheral surface of the housing bonding part 122, and at least two elastic deformation parts 126 may be provided. Although the case in which three elastic deformation parts 126 are extended from the housing bonding part 122 has been shown in FIGS. 1 to 4 by way of example in the present embodiment, the present invention is not limited thereto.

In addition, the elastic deformation part 126 may have one end connected to the housing bonding part 122 and the other end connected to the above-mentioned installation plate 124.

Further, the elastic deformation part 126 may have a spiral shape.

In addition, the elastic deformation part 126 may protrude upwardly from the housing bonding part 122. Therefore, the elastic deformation part 126 may be disposed to be inclined when viewed from the front.

That is, in the case in which the elastic deformation part 126 is not expanded, the other end portion of the elastic deformation part 126 may protrude upwardly from the housing bonding part 122.

In addition, in the case in which power is applied to the piezoelectric element 130, the elastic deformation part 126 may vibrate vertically.

Meanwhile, although the case in which the elastic member 120 is fixedly attached to the bracket 114 has been described by way of example in the present embodiment, the present invention is not limited thereto. That is, the elastic member 120 may also be fixedly attached to the upper case 112.

The piezoelectric element 130 may be fixedly attached to a lower surface of a central portion of the elastic member 120. That is, the piezoelectric element 130 may be fixedly attached to a lower surface of the installation plate 124 and be expanded when power is applied thereto.

Meanwhile, the piezoelectric element 130 may have a coin-like shape. In other words, the piezoelectric element 130 may have a circular shape when viewed from above.

As described above, the vibration generating apparatus 100 may generally have a coin-like shape through the piezoelectric element 130 having the coin-like shape.

Although not shown in detail in the accompanying drawings, a lower surface of the piezoelectric element 130 may be provided with an electrode for connection to the circuit board 150.

The mass body 140 may be fixedly attached to an upper surface of the central portion of the elastic member 120. That is, the mass body 140 maybe fixedly attached to an upper surface of the installation plate 124 of the elastic member 120.

Meanwhile, the mass body 140 may include a mass body case 142 fixedly attached to the upper surface of the central portion of the elastic member 120, that is, the installation plate 124, and a mass body 144 inserted into the mass body case 142.

The mass body case 142 may have a cylindrical shape in which a lower end portion thereof is closed so that the mass body 144 may be inserted thereinto. In addition, a lower surface of the mass body case 142 may be fixedly attached to the upper surface of the installation plate 124.

The mass body 144 may have a shape corresponding to that of the mass body case 142 and have a coin-like shape.

In addition, the mass body 144 may be formed of a material having a high specific gravity, for example, a tungsten material, in order to amplify vibrations at the time of deformation of the piezoelectric element 130.

Meanwhile, although the case in which the mass body 140 includes the mass body case 142 and the mass body 144 has been described by way of example in the present embodiment, the present invention is not limited thereto. For example, the mass body case 142 may be omitted. That is, the mass body 144 may also be directly installed on the installation plate 124.

The circuit board 150 may have one end connected to the piezoelectric element 130 and the other end drawn out to the outside of the housing 120.

Meanwhile, the circuit board 150, which vibrates together with the elastic member 120 at the time of deformation of the elastic member 120, may be formed of a flexible material. That is, the circuit board 150 may be a flexible printed circuit board (FPCB).

Meanwhile, the other end of the circuit board 150 may be provided with an external power supply connection terminal 152 for connection to an external power supply.

Meanwhile, although not shown in detail in the accompanying drawings, the vibration generating apparatus 100 according to the embodiment of the present invention may further include a damper member so as to prevent contact between the housing 110 and vibrating components.

In other words, the damper member may be installed on at least one of the housing 110 and the mass body 140 in order to prevent contact between the housing 110 and the mass body 140. In addition, the damper member may be installed on at least one of a lower surface of the piezoelectric element 130 and an upper surface of the bracket 114 of the housing 110 in order to prevent contact between the housing 110 and the piezoelectric element 130.

Further, the damper member may be formed of at least one of a magnetic fluid, a rubber, and a synthetic resin.

As described above, the vibration generating apparatus 100 may generally have a coin-like shape through the piezoelectric element 130 having the coin-like shape.

Therefore, since the entire volume may be decreased, miniaturization of the vibration generating apparatus may be implemented.

Further, since the piezoelectric element 130 has the coin-like shape, damage to the piezoelectric element 130 may be decreased in the case of an external impact, for example, a drop impact.

Hereinafter, a vibration generating apparatus according to another embodiment of the present invention will be described with reference to the accompanying drawings. However, the same components as the above-mentioned components will be denoted by the same reference numerals, and a detailed description thereof will be replaced by the above-mentioned description and omitted.

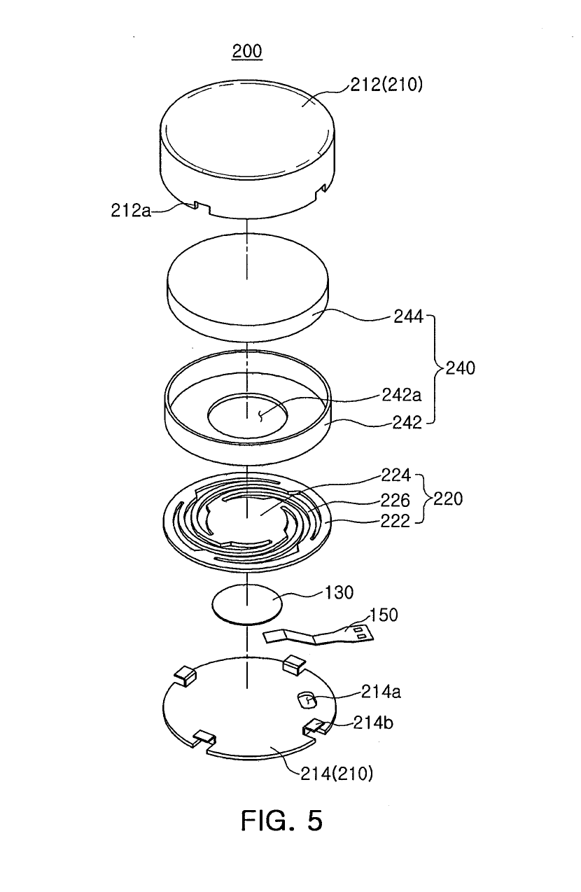

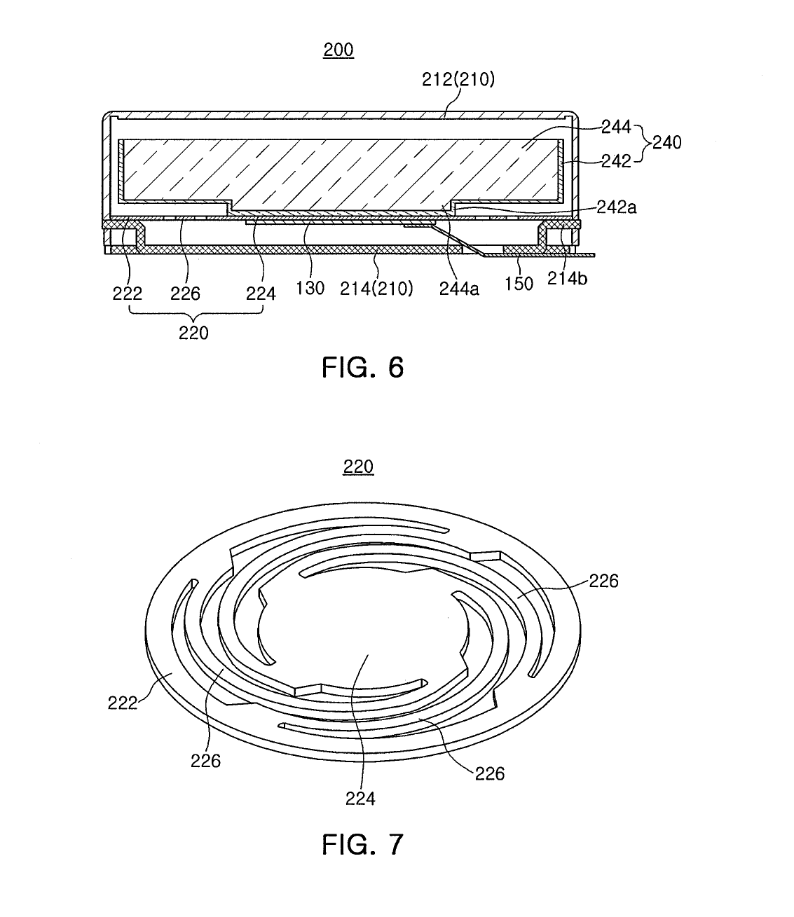

FIG. 5 is an exploded perspective view showing a vibration generating apparatus according to another embodiment of the present invention; FIG. 6 is a cross-sectional view showing the vibration generating apparatus according to another embodiment of the present invention; and FIG. 7 is a perspective view showing an elastic member included in the vibration generating apparatus according to another embodiment of the present invention.

Referring to FIGS. 5 through 7, the vibration generating apparatus 200 according to another embodiment of the present invention may include a housing 210, an elastic member 220, a piezoelectric element 130, a mass body 240, and a circuit board 150 by way of example.

Meanwhile, since the piezoelectric element 130 and the circuit board 150 are the same as the piezoelectric element 130 and the circuit board 150 included in the vibration generating apparatus 100 according to the embodiment of the present invention described above, a detailed description thereof will be omitted and be replaced by the above-mentioned description.

The housing 210 may have an internal space. To this end, the housing 210 may include an upper case 212 and a bracket 214.

The upper case 212 may have a cylindrical shape in which an upper end portion thereof is closed. That is, the upper case 212 may have the internal space and an opened lower end portion and have a circular shape when viewed from above.

However, the upper case 212 is not limited to having the cylindrical shape, but may also have a box shape, for example, a cube shape in which a lower end portion thereof is opened.

Meanwhile, a lower end portion of the upper case 212 may be provided with insertion grooves 212a for assembly between the upper case 212 and the bracket 214.

The bracket 214 may be attached to the lower end portion of the upper case 212 and have a plate shape. That is, the bracket 214 may have a shape corresponding to that of the upper case 212, for example, a circular shape when viewed from above.

In addition, the shape of the bracket 214 may be changed according to a deformation of the shape of the upper case 212.

Further, the bracket 214 may have a withdrawal hole 214a formed therein so that a circuit board 150 may be drawn out to the outside.

Meanwhile, the bracket 214 may be provided with support jaws 214b for supporting an edge of the elastic member 220.

A plurality of support jaws 214b, for example, four support jaws 214b, may be disposed at an edge of the bracket 214 in a circumferential direction so as to be spaced apart from each other. However, the number of support jaws 214b is not limited thereto, but may also be three or five or more.

Further, the support jaw 214b may also be formed at the edge of the bracket 214 in the circumferential direction so as to have a ring shape.

In addition, the support jaw 214b may be bent so as to support the edge of the elastic member 120. That is, the support jaw 214b may be bent twice.

Meanwhile, the support jaws 214b maybe inserted into the insertion grooves 212a of the upper case 212 at the time of assembling the upper case 212 and the bracket 214 to each other.

The elastic member 220 may have an edge part fixedly attached to the housing 210. Meanwhile, the elastic member 220 may include a housing bonding part 222 fixedly attached to the housing 210 and having a ring shape, an installation plate 224 having the piezoelectric element 130 and the mass body 240 fixedly attached thereto, and an elastic deformation part 226 connecting the housing bonding part 222 and the installation plate 224 to each other and providing elastic force.

The housing bonding part 222 may be fixedly attached to the bracket 214 of the housing 210 and have a circular ring shape so as to correspond to the shape of the bracket 214. That is, the housing bonding part 222 may be fixedly attached to the support jaws 214b of the bracket 214.

However, the shape of the housing bonding part 222 may also be variously changed so as to correspond to that of the bracket 214.

The installation plate 224 may have a circular plate shape and be connected to the elastic deformation part 226.

In addition, the installation plate 224 may be disposed to be co-planar with the housing bonding part 222. In other words, the installation plate 224 may be disposed in parallel with the housing bonding part 222.

In addition, the installation plate 224 may be connected to a plurality of elastic deformation parts 226 to thereby move upwardly and downwardly at the time of movement of the elastic deformation parts 226.

Meanwhile, the elastic deformation parts 226 may be extended from an inner peripheral surface of the housing bonding part 222, and the number of elastic deformation parts 126 may be at least two. Although the case in which three elastic deformation parts 226 are extended from the housing bonding part 222 has been shown in FIGS. 1 to 4 by way of example in the present embodiment, the present invention is not limited thereto.

In other words, the elastic deformation part 226 may have one end connected to the housing bonding part 222 and the other end connected to the above-mentioned installation plate 224.

Further, the elastic deformation part 226 may have a spiral shape.

In addition, the elastic deformation part 226 may be disposed in parallel with the housing bonding part 222. Therefore, the elastic member 220 may a plate shape when viewed from the front.

In addition, in the case in which power is applied to the piezoelectric element 130, the elastic deformation part 226 may vibrate vertically.

Meanwhile, although the case in which the elastic member 220 is fixedly attached to the bracket 214 has been described by way of example in the present embodiment, the present invention is not limited thereto. That is, the elastic member 220 may also be fixedly attached to the upper case 212.

The mass body 240 may be fixedly attached to an upper surface of the central portion of the elastic member 220. That is, the mass body 240 may be fixedly attached to an upper surface of the installation plate 224 of the elastic member 220.

Meanwhile, the mass body 240 may include a mass body case 242 fixedly attached to the upper surface of the central portion of the elastic member 220, that is, the installation plate 224, and a mass body 244 inserted into the mass body case 242.

The mass body case 242 may have a cylindrical shape in which a lower end portion thereof is closed so that the mass body 244 may be inserted thereinto. In addition, the mass body case 242 may be provided with a protrusion part 242a so as to prevent interference with the elastic member 220 at the time of vibration of the elastic member 220. That is, the mass body case 242 may include the protrusion part 242a protruding downwardly. In addition, a lower surface of the protrusion part 242a may be fixedly attached to the upper surface of the installation plate 224.

The mass body 244 may have a shape corresponding to that of the mass body case 242 and have a coin-like shape. In addition, the mass body 244 may be provided with a protrusion corresponding part 244a into which the above-mentioned protrusion part 242a is inserted.

In addition, the mass body 244 may be formed of a material having a high specific gravity, for example, a tungsten material, in order to amplify vibrations at the time of deformation of the piezoelectric element 130.

Meanwhile, although the case in which the mass body 240 includes the mass body case 242 and the mass body 244 has been described by way of example in the present embodiment, the present invention is not limited thereto. For example, the mass body case 242 may be omitted. That is, the mass body 244 may also be directly installed on the installation plate 224.

Meanwhile, although not shown in detail in the accompanying drawings, the vibration generating apparatus 200 according to another embodiment of the present invention may further include a damper member so as to prevent contact between the housing 210 and vibrating components.

As described above, the vibration generating apparatus 200 may generally have a coin-like shape through the piezoelectric element 130 having the coin-like shape.

Therefore, since the entire volume may be decreased, miniaturization of the vibration generating apparatus may be implemented.

Further, since the piezoelectric element 130 has the coin-like shape, damage to the piezoelectric element 130 may be decreased in the case of an external impact, for example, a drop impact.

As set forth above, according to the embodiments of the present invention, the vibration generating apparatus may generally have a coin-like shape through the piezoelectric element having a circular shape when viewed from above.

While the present invention has been shown and described in connection with the embodiments, it will be apparent to those skilled in the art that modifications and variations can be made without departing from the spirit and scope of the invention as defined by the appended claims.

What is claimed is:

1. A vibration generating apparatus comprising:
a housing having an internal space;
an elastic member having an edge part fixedly attached to the housing;
a piezoelectric element fixedly attached to a lower surface of a central portion of the elastic member; and
a mass body fixedly attached to an upper surface of the central portion of the elastic member.

2. The vibration generating apparatus of claim 1, wherein the piezoelectric element has a coin-like shape.

3. The vibration generating apparatus of claim 1, wherein the elastic member includes a housing bonding part fixedly attached to the housing and having a ring shape, an installation plate having the piezoelectric element and the mass body fixedly attached thereto, and an elastic deformation part connecting the housing bonding part and the installation plate to each other and providing elastic force.

4. The vibration generating apparatus of claim 3, wherein the housing bonding part and the installation plate are disposed to be spaced apart from each other by a predetermined interval in a thickness direction of the housing, and
the elastic deformation part is disposed to be inclined.

5. The vibration generating apparatus of claim 1, wherein the mass body includes a mass body case fixedly attached to the upper surface of the central portion of the elastic member and a mass body inserted into the mass body case.

6. The vibration generating apparatus of claim 1, wherein the housing includes an upper case having a cylindrical shape in which an upper end portion thereof is closed and a bracket attached to a lower end portion of the upper case, and
the upper case and the bracket have a circular shape when viewed from above.

7. The vibration generating apparatus of claim 6, wherein the bracket is provided with support jaws for supporting an edge of the elastic member.

8. The vibration generating apparatus of claim 7, wherein a plurality of support jaws are disposed in a circumferential direction so as to be spaced apart from each other and be formed in a ring.

9. The vibration generating apparatus of claim 1, further comprising a circuit board having one end connected to the piezoelectric element and the other end drawn out to the outside of the housing.

10. The vibration generating apparatus of claim 9, wherein the housing includes an upper case having a cylindrical shape in which an upper end portion thereof is closed and a bracket attached to a lower end portion of the upper case, and
the bracket is provided with a withdrawal hole through which the other end of the circuit board is drawn out.

11. A vibration generating apparatus comprising:
a housing including an upper case having a cylindrical shape in which an upper end portion thereof is closed and a bracket attached to a lower end portion of the upper case and having a plate shape;
an elastic member including a housing bonding part fixedly attached to the bracket, a plurality of elastic deformation parts extended from the housing bonding part, and an installation plate having the plurality of elastic deformation parts connected thereto;
a piezoelectric element fixedly attached to a lower surface of the installation plate of the elastic member;
a mass body case fixedly attached to an upper surface of the installation plate;
a mass body inserted into the mass body case; and
a circuit board having one end connected to the piezoelectric element and the other end drawn out to the outside of the housing.
